(19) United States
(12) Patent Application Publication
(10) Pub. No.: US 2011/0174292 A1
(43) Pub. Date: Jul. 21, 2011

(54) Foot Activated Grill Opening Apparatus and Method

(76) Inventor: Steve Richards, Melbourne, FL (US)

(21) Appl. No.: 13/009,380

(22) Filed: Jan. 19, 2011

Related U.S. Application Data
(60) Provisional application No. 61/296,562, filed on Jan. 20, 2010.

(51) Int. Cl. A47J 37/07; B65D 43/26

(52) U.S. Cl. 126/25 R; 220/262

(57) ABSTRACT

A foot activated grill opening apparatus and method for reducing the chance of user injury and eliminating awkwardness when opening and closing the cover of a grill. The apparatus allows a user to open the cover of a grill in a hands-free fashion. The present invention allows a user carrying utensils and plates in both hands to still open and close the cover of a grill. Additionally, the apparatus further reduces the chance of user injury from contact burns, radiant heat burns, grill flare-ups, and the like that may occur when a user reaches across and above a grill's heat source while opening and closing a grill cover in a conventional manner. The present invention further provides aid to elderly and weaker individuals incapable of either lifting the weight of the grill cover or generating the necessary shoulder/arm range of motion to open the grill cover.

### CROSS REFERENCE TO RELATED APPLICATIONS

This U.S. utility patent application builds upon and claims priority to the previously filed U.S. provisional patent application No. 61/296,562 carrying a filing date in the USPTO of Jan. 20, 2010 (20January2010), which is specifically incorporated herein by reference in its entirety.

### STATEMENT REGARDING FEDERALLY SPONSORED RESEARCH OR DEVELOPMENT

Not applicable.

### INCORPORATION-BY-REFERENCE OF MATERIAL SUBMITTED ON A COMPACT DISK

Not applicable.

### BACKGROUND OF THE INVENTION

1. Field of the Invention

The present invention generally relates to grills, more specifically, the present invention relates to a mechanical foot activated grill opening apparatus allowing for hands-free opening of a grill.

2. Background Art

An outdoor cooking grill, also commonly referred to as a “barbecue grill,” “barbecue,” or simply “grill,” may include a hinged cover that encloses the cooking surface. A hinged cover is a particularly common feature of grills fueled by propane and natural gas, though other grills may have covers as well.

Keeping the grill cover closed during cooking retains a remarkable amount of the heat and moisture (at least fifty to seventy five percent) along with other gases, promoting even and thorough cooking. When keeping the cover closed there is less chance of charring (blackening) the foods because the moisture is enclosed. The applicant's present embodiments are directed toward the significant easing of the operation of opening the cover of cooking instruments, grills and the like, in a manner that focuses on substantially improving the overall operation and safety of the grill cover while cooking.

Outdoor grills are typically designed with a handle affixed to the front of the grill cover. In the course of food preparation, it is necessary to manually lift the grill cover in order to gauge the progress of the food preparation. On conventional grills, the grill cover opens upward and away from the person lifting the cover. The cover is inevitably placed in a resting position, leaning behind and away from the grill frame. When carrying a plate of food and cooking utensils, many people find the conventional process for opening a grill cover to be very awkward and ill-manageable.

Additionally, the conventional hinge design of grill covers is itself awkward and somewhat dangerous as the operator has to place his hands or a suitable tool near the heat source each time the cover is opened or closed. The typical design and placement of the grill cover handle may unnecessarily expose a user to injury from heat, flame bursts, and the like when opening the grill cover. A user typically grabs the grill cover handle, grasping it from the closed position until the cover reaches its resting position. As such, the user's arm is momentarily directly above the heat emanating from the heating element used in the grill. In addition, many grill covers are designed such that a user's arm can inadvertently contact the grill cover while the cover is being lifted or closed. The user also has to carry the bulk of the cover's weight as it is pivoted open on the rear located hinge, which is particularly problematic for heavy ceramic grill covers. Thus, it can be seen that needs exist for a hands-free way of opening and closing a grill with a hinged cover. It is to such an apparatus and method that the present invention is directed.

### BRIEF SUMMARY OF THE INVENTION

The present invention comprises a system and/or method that have one or more of the following features and/or steps, which alone or in any combination may comprise patentable subject matter.

In accordance with one embodiment of the present invention, the invention may comprise a device for foot operation of a cover of a grill having a frame base, comprising a contact bar, wherein the contact bar provides a surface upon which an activation force may be applied and at least one connector arm, wherein a first end of the at least one connector arm is connected to the contact bar and a second end of the at least one connector is connected to the cover of the grill.

In accordance with another embodiment of the present invention, the invention may comprise a method for foot operation of a cover of a grill having a frame base, comprising the steps of providing a foot operative device, the device comprising a contact bar, wherein the contact bar provides a surface upon which an activation force may be applied and at least one connector arm, wherein a first end of the at least one connector arm is connected to the contact bar and a second end of the at least one connector is connected to the cover of the grill; applying the activation force upon the contact bar, wherein application of the activation force upon the contact bar moves the contact bar away from the cover thereby pulling the at least one connector arm and causing the cover to rotate relative to the frame base; and moving the cover to an open position relative to the frame base of the grill.

### BRIEF DESCRIPTION OF THE DRAWINGS

A better understanding of the present invention will be realized from the detailed description that follows, taken in conjunction with the accompanying drawings, in which:

FIG. 1 depicts a front view of a grill incorporating the apparatus of the present invention wherein the grill cover is in the closed position.

FIG. 2 depicts a side view of the grill incorporating the apparatus of the present invention of FIG. 1 wherein the grill cover is in the closed position.

FIG. 3 depicts a front view of the grill incorporating the apparatus of the present invention of FIG. 1 wherein the grill cover is in the open position.

FIG. 4 depicts a side view of the grill incorporating the apparatus of the present invention of FIG. 3 wherein the grill cover is in the open position.

FIG. 5 depicts a perspective view of the grill incorporating the apparatus of the present invention of FIG. 1 wherein the grill cover is in the closed position.

FIG. 6 depicts a perspective view of the grill incorporating the apparatus of the present invention of FIG. 5 wherein the grill cover is in the open position.

FIG. 7 depicts a front view of a grill incorporating another embodiment of an apparatus of the present invention wherein the grill cover is in the open position.

FIG. 8 depicts a side view of the grill incorporating the embodiment of the apparatus of the present invention of FIG. 7 wherein the grill cover is in the open position.

FIG. 9 depicts a front view of the grill incorporating the embodiment of the apparatus of the present invention of FIG. 7 wherein the grill cover is in the closed position.

FIG. 10 depicts a side view of the grill incorporating the embodiment of the apparatus of the present invention of FIG. 7 wherein the grill cover is in the closed position.

FIG. 11 depicts a perspective view of the grill incorporating the embodiment of the apparatus of the present invention of FIG. 7 wherein the grill cover is in the closed position.

FIG. 12 depicts a perspective view of the grill incorporating the embodiment of the apparatus of the present invention of FIG. 7 wherein the grill cover is in the open position.

### DETAILED DESCRIPTION OF THE INVENTION

Although the following detailed description contains many specifics for the purposes of illustration, anyone of ordinary skill in the art will appreciate that many variations and alterations to the following details are within the scope of the invention. Accordingly, the following preferred embodiments of the invention are set forth without any loss of generality to, and without imposing limitations upon, the claimed invention.

The apparatus and method of the present invention facilitates safety and burn prevention when opening a grill cover. The present invention may assist a wide assortment of individuals including but not limited to users with their hands full of utensils or plates, individuals with weak upper body strength, individuals with a reduced physical range of motion, and the like. When a user simply steps on the contact bar that is disposed parallel to and just above the floor or other support surface, downward movement of the contact bar causes the grill cover to open. In such a manner, users need only apply a portion of their body weight, minimal muscular force from their lower extremities, or any other activation force to the contact bar to move the grill cover from a closed position into and open position.

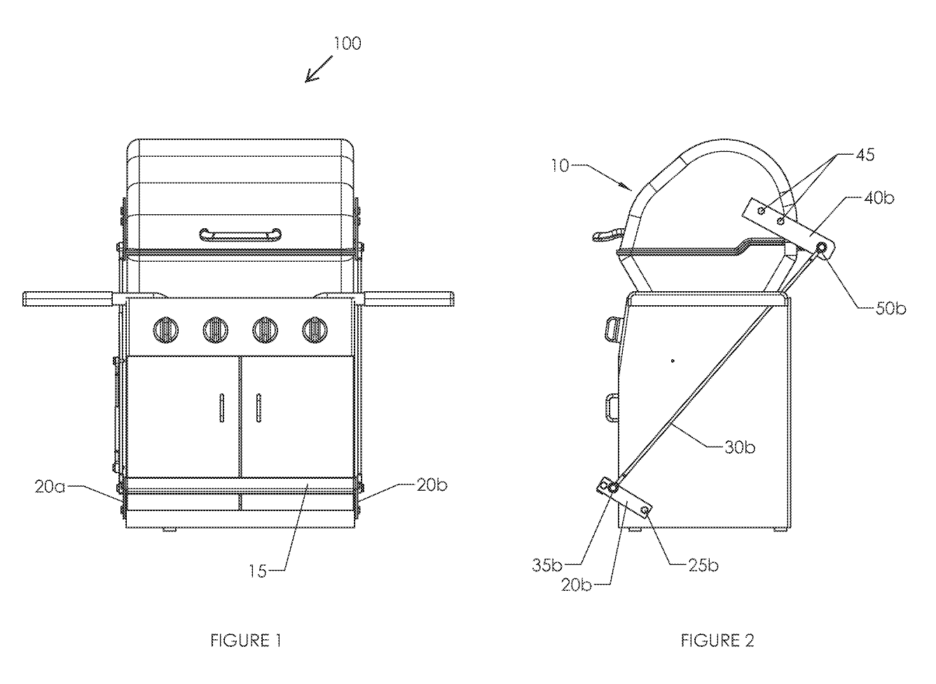

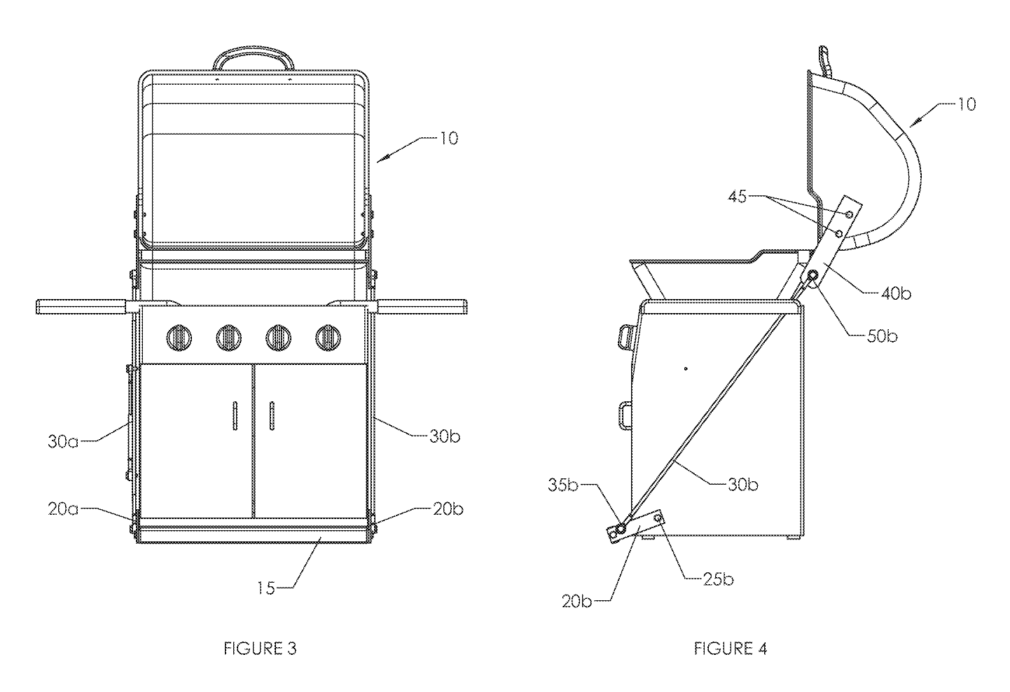

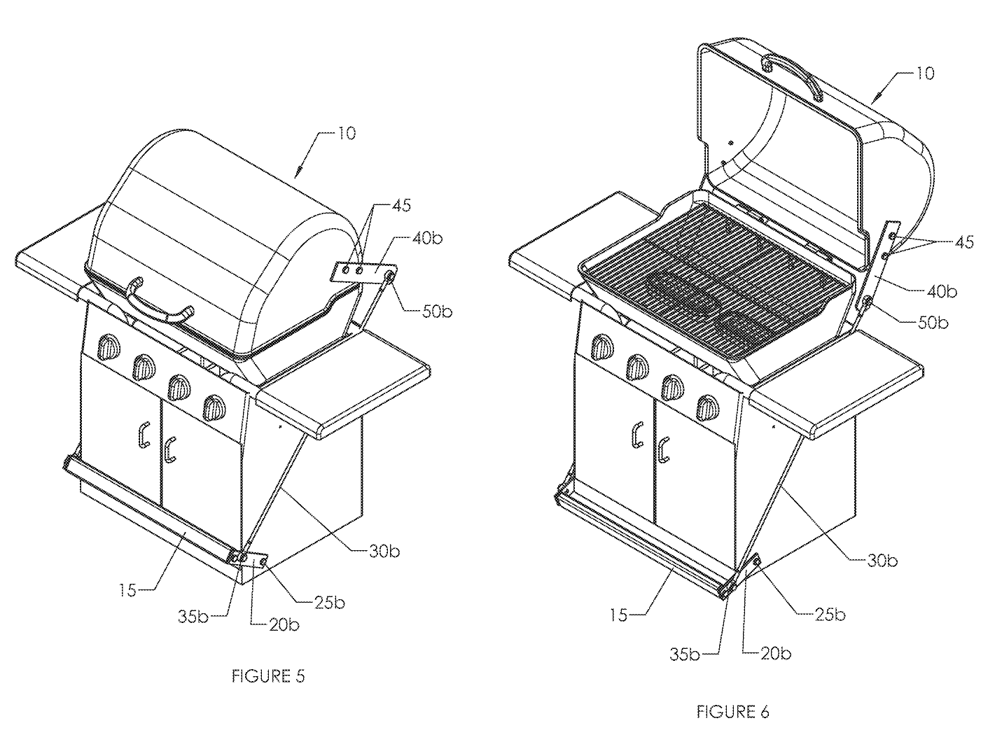

A preferred embodiment of the foot activated grill opening apparatus of the present invention is illustrated in FIGS. 1-6. FIGS. 1-2 depict a front view and a side view of a conventional grill 100 incorporating the apparatus of the present invention, wherein the cover 10 is shown in the closed position relative to the frame base of the grill 100. FIGS. 3-4 depict a front view and a side view of the same conventional grill 100 wherein the cover 10 is shown in the open position relative to the frame base of the grill 100. The apparatus, as best seen in the perspective views of FIGS. 5-6, may comprise a contact bar 15 that provides the point of interaction between the apparatus and a user. Preferably the apparatus is symmetrical and comprises matching elements on both the left and right sides of the grill 100; however, the scope of the present invention also includes asymmetrical embodiments and their equivalents.

The components of the apparatus of the present invention may be altered within the scope of the invention to allow for incorporation of the invention onto a grill of any size, shape, or dimensions. The examples provided depict use of the apparatus on a typical rectangular-shaped grill but the scope of the invention includes use of the apparatus on rectangular grills, square grills, circular grills, and any other grill shapes or configurations known within the art.

The contact bar 15 may comprise a horizontal bar that is disposed adjacent the lower front region of the frame base of the grill 100. When the cover 10 of the grill 100 is in the closed position, the contact bar 15 may be elevated above the floor or other support surface as shown in FIGS. 1-2 and 5. When a user steps on or otherwise applies downward force to the contact bar 15, the contact bar 15 is depressed and may either contact the support surface or reach the end of its downward range of motion before contacting the support surface. Downward movement of the contact bar 15 provides the mechanical force necessary for the apparatus to pivot the cover 10 of the grill 100 into the open position (see FIGS. 3-4 and 6).

Ends of the contact bar 15 may be secured to at least one lower arm. In a preferred embodiment, the contact bar 15 may be secured to at least one lower arm. In a preferred embodiment the ends of the contact bar 15 may be secured to a first lower arm 20a and a second lower arm 20b respectively (see FIGS. 1-6). The first lower arm 20a may be pivotally secured to a lower portion of the frame base of the grill 100 at a first lower arm connection 25a. Likewise, second lower arm 20b may be pivotally secured to the lower portion of the frame base of the grill 100 at a second lower arm connection 25b. The respective first and second lower arm connections 25a,25b may preferably comprise pivotal connections wherein the contact bar 15 pivots about an axis created by the first and second lower arm connections 25a,25b. When a user steps on or otherwise applies an activation force upon the contact bar 15, the contact bar 15 may then pivot from an elevated position to a depressed position relative to the support surface on which the grill 100 rests.

In an alternate embodiment, respective first and second lower arm connections 25a,25b may comprise slidable connections to the frame base of the grill 100 wherein the contact bar 15 slides up and down in a fixed-plane range of motion that is parallel to the front surface of the frame base of the grill 100. Such first and second lower arm connections 25a,25b may provide for vertical travel and movement of the first and second lower arms 20a,20b wherein at least one spring may bias the first and second lower arms 20a,20b into the upper end of their range of motion. When a user steps on or otherwise applies force upon the contact bar 15, the contact bar 15 then vertically slides from a biased elevated position to a depressed position relative to the support surface.

FIGS. 1-2 and FIG. 5 show different perspectives of a contact bar 15 embodiment having a pivotal connection and its associated adjacent structures wherein the contact bar 15 is in the elevated position and the cover 10 of the grill 100 is in the closed position. FIGS. 3-4 and 6 show different perspectives of the contact bar 15 and its associated adjacent structures wherein the contact bar 15 is in the depressed position and the cover 10 of the grill 100 is in the open position.

Force is transferred from the contact bar 15 up to the cover 10 of the grill by at least one connector arm. In a preferred embodiment, the at least one connector arm may comprise a first connector arm 30a and a second connector arm 30b. The first and second connector arms 30a,30b may each comprise a rigid rod, but the scope of the present invention includes and is not limited to first and second connector arms 30a,30b comprising a bar, cable, wire, string, chain, belt, rope, strap or connecting structures known within the art. The purpose and function of any embodiment of the first and second connector arms 30a,30b is to transfer the activation forced applied to the contact bar 15 to at least one upper arm that transfers the force to the grill cover 10.

The first connector arm 30a may be attached to the first lower arm 20a at the first lower connection 35a and the first connector arm 30a then extends upward to a region adjacent the cover 10. At the position adjacent the cover 10, the first connector arm 30a may attach to at least one upper arm. In a preferred embodiment, the at least one upper arm may comprise a first and second upper arm 40a,40b. The first connector arm 30a may attach to the first upper arm 40a at a first upper connection 50a. The first upper arm 40a may be secured to the cover 10 by at least one fastener 45, wherein the at least one fastener 45 may include but is not limited to a screw, bolt, rivet, welded joint or any equivalent fastener known within the art. Similarly, the second connector arm 30b may be attached to the second lower arm 20b at the second lower connection 35b and the second connector arm 30b then extends upward to a region adjacent the cover 10. At its position adjacent the cover 10, the second connector arm 30b may attach to a second upper arm 40b at a second upper connection 50b. The second upper arm 40b may be secured to the cover 10 by at least one fastener 45, wherein the at least one fastener 45 may include but is not limited to a screw, bolt, rivet, welded joint or any equivalent fastener known within the art. In a preferred embodiment, the first and second upper connections 50a,50b comprise pivotal connections.

As best seen in FIG. 2 and FIG. 4 and dependent on the specific structure of the grill 100, portions of the grill 100 may require structural alterations to allow for free and unobstructed movement of elements of the inventive apparatus including but not limited to the first and second connector arms 30a,30b; the first and second upper arms 40a,40b; and the first and second upper connections 50a,50b. Such a determination will need to be made on a case-by-case basis for allowing free movement of the apparatus of the present invention.

FIG. 2 and FIGS. 4-6 depict the second upper arm 40b being secured to the cover 10 of the grill 100 by at least one fastener 45, wherein an embodiment having two fasteners 45 is shown. The grill cover 10 depicted in FIGS. 1-2 and FIG. 5 is shown in the closed position. Upon user application of an activation force upon the contact bar 15, the second upper connection 50b and first upper connection 50a (not shown) are pulled downward by their respective first and second connector arms 30a,30b thereby imparting a pivotal force about the pre-existing pivot joint disposed between the cover 10 and the frame base of the conventional grill 100. A release of or a decrease in the activation force applied to the contact bar 15 may allow the weight of the grill cover 10 to impart a reversing pivotal force about the pre-existing pivot joint that acts to bring the cover 10 back into the closed position.

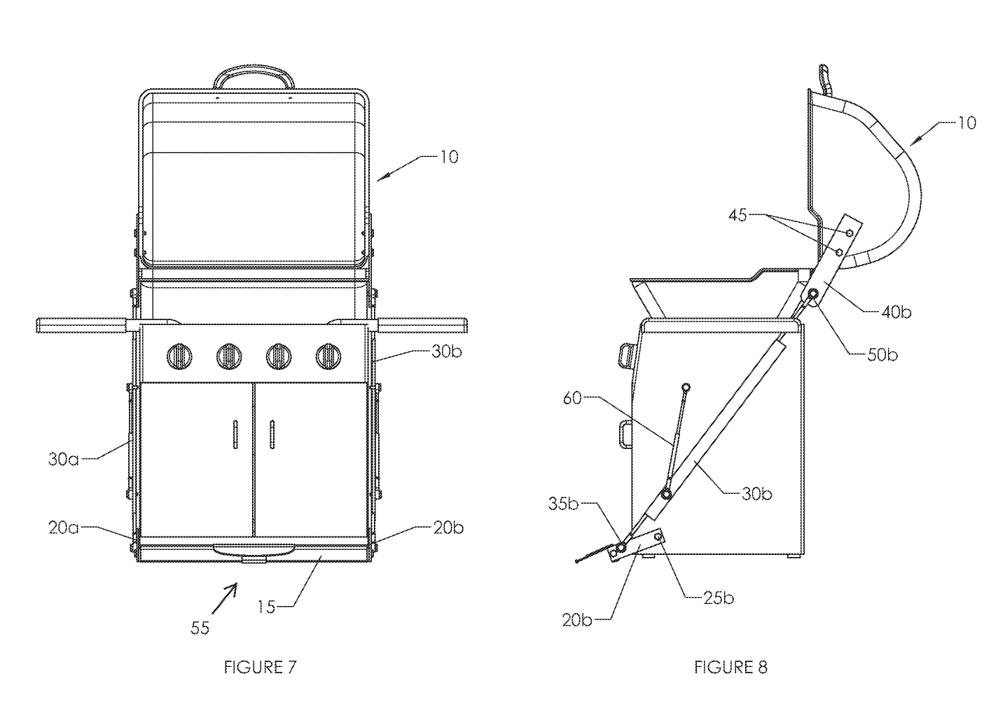

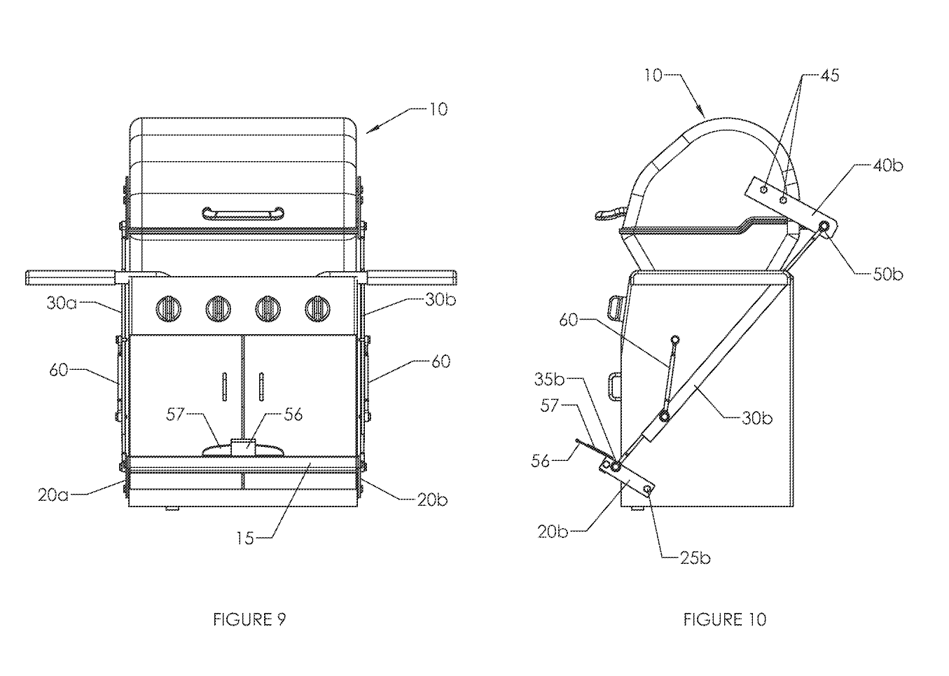

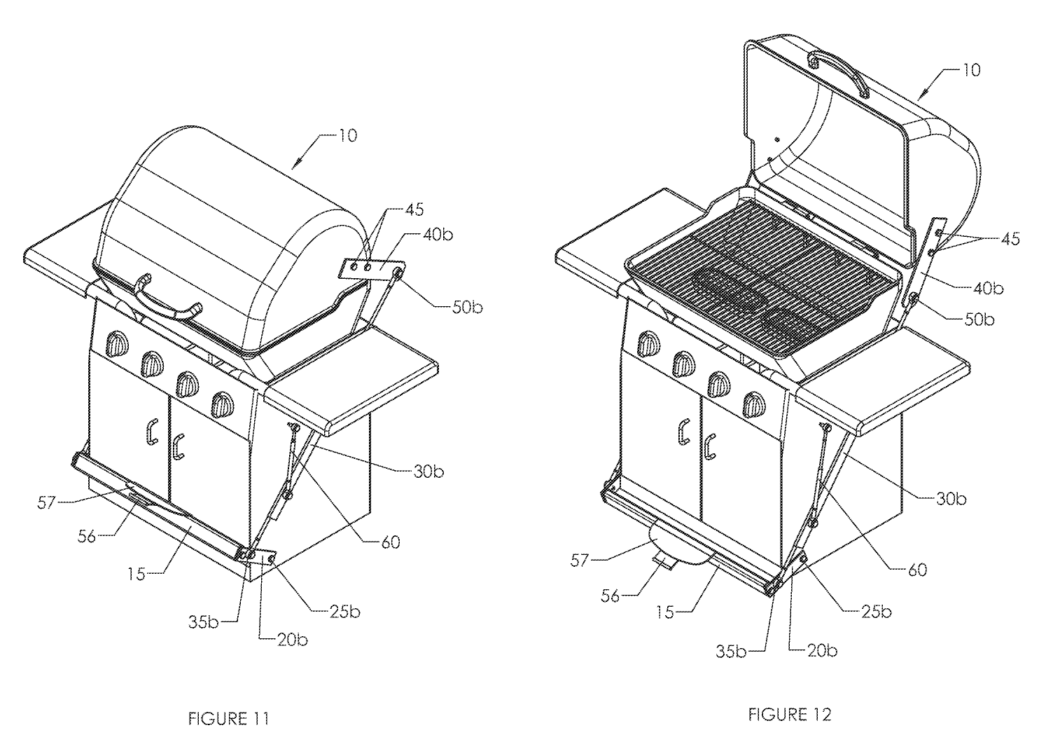

FIGS. 7-12 depict the use of a traction-enhancing element 55. The traction-enhancing element 55 may be used to allow for easier and more reliable foot placement and pressure application by a user to the contact bar 15. Preferred embodiments of the traction-enhancing element 55 may increase the traction of the surface exposed to the user's foot including but not limited to diamond plate, friction tape, knurled textures. Other characteristics of the traction-enhancing element 55 may include a unitary or separate structural component for increasing the surface area of the contract bar 15 thereby allowing for easier user manipulation as needed, wherein such structures may include but are not limited to oblique extensions relative to the contact bar 15, perpendicular extensions 56 relative to the contact bar 15, one or more portions having increased dimensions 57 of width and/or length relative to the contact bar 15, and the like. FIGS. 7-12 depict one embodiment of a traction-enhancing element 55 comprising a perpendicular extension 56 extending from the contact bar 15 and a portion of increased width 57 having diamond-plated tractions protrusions thereon. The increased surface area and traction protrusions combine to improve and facilitate a user's activation of the contact bar 15 as needed to open the grill cover 10. Such traction-enhancing elements 55 may be omitted, used alone, or used in any combinations thereof.

FIGS. 7-12 also depict the use of one or more dampeners 60. The one or more dampeners 60 may comprise any structural element or configuration known within the art to slow, decelerate, or otherwise oppose the force of a moving body wherein such structures may including but not limited to hydraulic pistons, pneumatic pistons, springs, and the like. The one or more dampeners may have a first end attached to the frame base of the grill 100 and a second end thereof that may be attached to at least one connector arm (30a,30b), at least one side arm (20a,20b), or the contact bar 15.

The one or more dampeners 60 may function in a manner analogous to the pistons located in conventional screen doors. As shown in FIGS. 7-8 and FIG. 12, the one or more dampeners 60 may be biased to motivate the cover 10 into an open position. The weight of the cover 10 may prevent the cover 10 from opening without further assistance being provided by the application of an activation force upon the contact bar 15. Due to the bias of the one or more dampeners 60 to move the cover 10 to its open position, the one or more dampeners 60 may assist the user in moving the cover to the open position when the user applies a force to the contact bar 15. Likewise, the bias of the one or more dampeners 60 to move the cover 10 to its open position also brakes or slows any closing motion of the cover 10 as the cover 10 is lower or pulled down by gravity to a closed position. The user may additionally apply an activation force to the contact bar 15 to further assist in slowing the descent of the cover 10 as it moves from an open position to a closed position. In alternate embodiments, the one or more dampeners 60 may also assist in maintaining the cover 10 in the open position if the cover 10 has moved past dead-center of the pivot point between the cover 10 and the frame base of the grill 100.

In use, a user may step on the contact bar 15 of the present inventive apparatus that may be installed upon a pre-existing or newly purchased conventional grill 100. Application of the activation force on the contact bar 15 pivots or slides the contact bar 15 from an elevated position to a depressed position relative to the floor or other support surface beneath the grill 100. When the contact bar 15 is in the elevated position the cover 10 of the grill 100 is closed and as the contact bar 15 is motivated into the depressed position the cover 10 of the grill 100 is moved into an open position. Application of a downward activation force on the contact bar 15 pulls the first and second connector arms 30a,30b to a lower relative position since the first and second connector arms 30a,30b may be secured to the first and second lower arms 20a,20b on either end of the contact bar 15, respectively. The downward displacement of the first and second connector arms 30a,30b further motivates the rear portion of both the first and second upper arms 40a,40b in a downward direction due to the location and positioning of the first and second upper connections 50a,50b, respectively. The downward displacement of the rear portion of both the first and second upper arms 40a,40b pulls down on the rear portion of the grill cover 10 thereby pivoting and lifting the front portion of the grill cover 10 from a closed position to an open position. The cover 10 pivots about the pre-existing pivot point disposed between the cover 10 and the lower frame base of the conventional grill 100.

Upon release of the activation force applied to the contact bar 15, if the center of gravity of the grill cover 10 has crossed over dead-center of the pivot point between the cover 10 and the frame base, the cover 10 will remain in an open position. If the center of gravity of the grill cover 10 has not crossed over dead center of the pivot point between the cover 10 and the frame base, however, the cover 10 will then reverse direction and return to a closed position due to the weight of the grill cover 10. Structural manipulation of the range of motion available to the grill cover 10 allows for adjustment or selection between a grill cover 10 that will remain open after a full activation force has been removed from the contact bar 15 (i.e. cover 10 passes over dead center of the pivot point with the grill frame base) and a grill cover 10 that will automatically assume or return to a closed position after a full activation force has been removed from the contact bar 15 (i.e. cover 10 does not pass over dead center of the pivot point with the grill frame base).

As disclosed above, one or more dampeners 60 may further be incorporated into any known embodiments of the present invention. The one or more dampeners 60 may be biased to motivate the cover 10 into its open position thereby assisting or providing a supplemental force when a user steps on or otherwise applies an activation force to the contact bar 15. In an embodiment where the cover 10 crosses over dead-center of the pivot point with the frame base, the cover 10 will remain in an open position with the additional help provided by the one or more dampeners 60. In any of the potential embodiment, the biasing force provided by the one or more dampeners 60 may oppose movement of the cover 10 from an open position to a closed position. In a preferred embodiment, the biasing force of the one or more dampeners 60 is enough to resist but not equal the downward closing force provided by the weight of the cover 10, wherein the one or more dampeners 60 prevent the cover 10 from forcefully slamming shut and provide for a controlled slower descent of the cover 10 to the closed position as the user's foot reduces the activation force on or is completely removed from the contact bar 15.

Accordingly the reader will see that the present invention may provide for a kit that allows for retrofitting the apparatus of the present invention onto pre-existing grills. Alternatively, the apparatus of the present invention may be pre-installed on new grills before the grills are sold to consumers.

Although a detailed description as provided in the attachments contains many specifics for the purposes of illustration, anyone of ordinary skill in the art will appreciate that many variations and alterations to the following details are within the scope of the invention. Accordingly, the following preferred embodiments of the invention are set forth without any loss of generality to, and without imposing limitations upon, the claimed invention. Thus the scope of the invention should be determined by the appended claims and their legal equivalents, and not merely by the preferred examples or embodiments given.

What is claimed is:

1. A device for foot operation of a cover of a grill having a frame base, comprising:
a contact bar, wherein said contact bar provides a surface upon which an activation force may be applied; and
at least one connector arm, wherein a first end of said at least one connector arm is connected to said contact bar and a second end of said at least one connector is connected to said cover of said grill.

2. The device of claim 1, further comprising:
at least one upper arm, wherein said at least one connection arm is connected to said cover by said at least one upper arm.

3. The device of claim 1, wherein said contact bar is attached to said frame base of said grill by at least one lower arm having at least one bar connection and said at least one bar connection comprises a pivotal connection.

4. The device of claim 1, wherein said contact bar is attached to said frame base of said grill by at least one lower arm having at least one bar connection and said at least one bar connection comprises a slidable connection.

5. The device of claim 1, wherein application of said activation force upon said contact bar moves said contact bar away from said cover thereby pulling said at least one connector arm and rotating said cover relative to said frame base of said grill.

6. The device of claim 1, wherein said contact bar is attached to said at least one connector arm by at least one lower connection and said at least one lower connection comprises a pivotal connection.

7. The device of claim 2, wherein said at least one connector arm is attached to said at least one upper arm by at least one upper connection and said at least one upper connection comprises a pivotal connection.

8. The device of claim 2, wherein said at least one upper arm is attached to said cover of said grill by at least one fastener.

9. The device of claim 1, wherein said contact bar further comprises a traction-enhancing element.

10. The device of claim 9, wherein said traction enhancing-element is selected from the group consisting of at least one perpendicular extension and one or more portions having increased dimensions.

11. The device of claim 1, further comprising:
one or more dampeners, wherein said one or more dampeners prevent said cover from slamming closed when said activation force is removed.

12. The device of claim 11, wherein said one or more dampeners are selected from the group consisting of hydraulic pistons and pneumatic pistons.

13. The device of claim 11, wherein said one or more dampeners comprises a first end attached to said frame base and a second end attached to said at least one connector arm.

14. The device of claim 3, further comprising:
one or more dampeners comprising a first end attached to said frame base and a second end attached to said at least one lower arm.

15. A method for foot operation of a cover of a grill having a frame base, comprising the steps of:
providing a foot operative device, said device comprising:
a contact bar, wherein said contact bar provides a surface upon which an activation force may be applied; and
at least one connector arm, wherein a first end of said at least one connector arm is connected to said contact bar and a second end of said at least one connector is connected to said cover of said grill;
applying said activation force upon said contact bar, wherein application of said activation force upon said contact bar moves said contact bar away from said cover thereby pulling said at least one connector arm and causing said cover to rotate relative to said frame base; and
moving said cover to an open position relative to said frame base of said grill.

16. The method of claim 15, wherein said contact bar is attached to said frame base of said grill by at least one bar connection and said at least one bar connection comprises a pivotal connection.

17. The method of claim 15, wherein said contact bar is attached to said at least one connector arm by at least one lower connection and said at least one lower connection comprises a pivotal connection, and wherein said at least one connector arm is attached to said cover by at least one upper arm, wherein said at least one upper arm comprises at least one upper connection and said at least one upper connection comprises a pivotal connection.

18. The method of claim 15, wherein said contact bar further comprises a traction-enhancing element and said traction-enhancing element is selected from the group consisting of at least one perpendicular extension and one or more portions having increased dimensions.

19. The method of claim 15, said device further comprises:
one or more dampeners, wherein said one or more dampeners prevent said cover from slamming closed when said activation force is removed and said one or more dampeners are selected from the group consisting of hydraulic pistons and pneumatic pistons.

20. The method of claim 15, wherein said one or more dampeners comprises a first end attached to said frame base and a second end attached to said at least one connector arm.
